(19) United States
(12) Patent Application Publication
(10) Pub. No.: US 2026/0111339 A1
(43) Pub. Date: Apr. 23, 2026

(54) VEHICLE STATE BASED APPLICATION VERIFICATION PROHIBITION

(71) Applicant: TOYOTA JIDOSHA KABUSHIKI KAISHA, Aichi-ken (JP)

(72) Inventors: Yuichi YOSHIMURA, Kawasaki-shi (JP); Mitsuo DATE, Funabashi-shi (JP); Yutaka TARUOKA, Anjo-shi (JP)

(21) Appl. No.: 18/924,967

(22) Filed: Oct. 23, 2024

(51) Int. Cl. G06F 11/36; G06F 11/30; G06F 11/32

(52) U.S. Cl. CPC G06F 11/3604; G06F 11/3013; G06F 11/328

(57) ABSTRACT

Vehicle state based application verification prohibition is implemented by receiving a command to execute an application, determining whether the application has been previously executed, detecting whether a vehicle is in a parked state in response to determining that the application has not been previously executed, and prohibiting a verification process for the application from proceeding in response to detecting that the vehicle is not in the parked state.

### BACKGROUND

A vehicle system is composed of many Electronic Controller Units (ECUs). Many ECUs are able to function as computers, with the ability to access externally-stored data and communicate through packet-based networks. Software applications are executed by ECUs to provide various services for the vehicle or a user thereof.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for vehicle state based application verification prohibition, according to at least some embodiments of the subject disclosure.

FIG. 2 is an operational flow for vehicle state based application verification prohibition, according to at least some embodiments of the subject disclosure.

FIG. 3 is an operational flow for verification process, according to at least some embodiments of the subject disclosure.

FIG. 4 is a block diagram of a hardware configuration for vehicle state based application verification prohibition, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

Certain software applications, such as those developed by third parties, perform operations that are harmful to the vehicle or the safety of users. Therefore, before a new application is executed by the vehicle, or an ECU thereof, it is desirable to verify the operation of the application in the vehicle. However, verification processes known to the inventors may consume significant computational resources, and may request input from the driver of the vehicle. During driving of the vehicle, use of computational resources and driver prompts are carefully regulated.

In at least some embodiments described herein, verification of operations of applications is prohibited while the vehicle is in motion. In at least some embodiments, verification is performed while the vehicle is parked. In at least some embodiments, a “parked” state is understood as stopped, not being driven, not moving, etc.

In at least some embodiments, performing verification while the vehicle is parked increases the likelihood that the verification is performed in a secure environment.

In at least some embodiments, verification of application operation while the vehicle is not parked is prohibited. In at least some embodiments, unverified applications are prohibited from execution until operation is verified. In at least some embodiments, unverified applications are prohibited from execution at least until the vehicle is parked. In at least some embodiments, conditions for the “parked” state include speed, gear engagement or disengagement, location, whether the vehicle is in manual mode or autonomous mode, etc., individually or in combinations thereof. In at least some embodiments, the “parked” state is detected through sensors such as a speedometer, gear sensor, location sensor, etc., individually or in combinations thereof. In at least some embodiments, a user of the vehicle verifies whether certain operations are operating normally. In at least some embodiments, one or more ECUs verify whether certain operations are operating normally. In at least some embodiments, if the application is for displaying vehicle information, then verification of the operation is in response to a difference between a value recognized in the vehicle and a value displayed in the application being equal to or less than a predetermined value. In at least some embodiments, in response to determining that an application is not operating normally, the application is deleted from the vehicle. In at least some embodiments, certain applications are not prohibited from proceeding through the operation verification process while the vehicle is not parked.

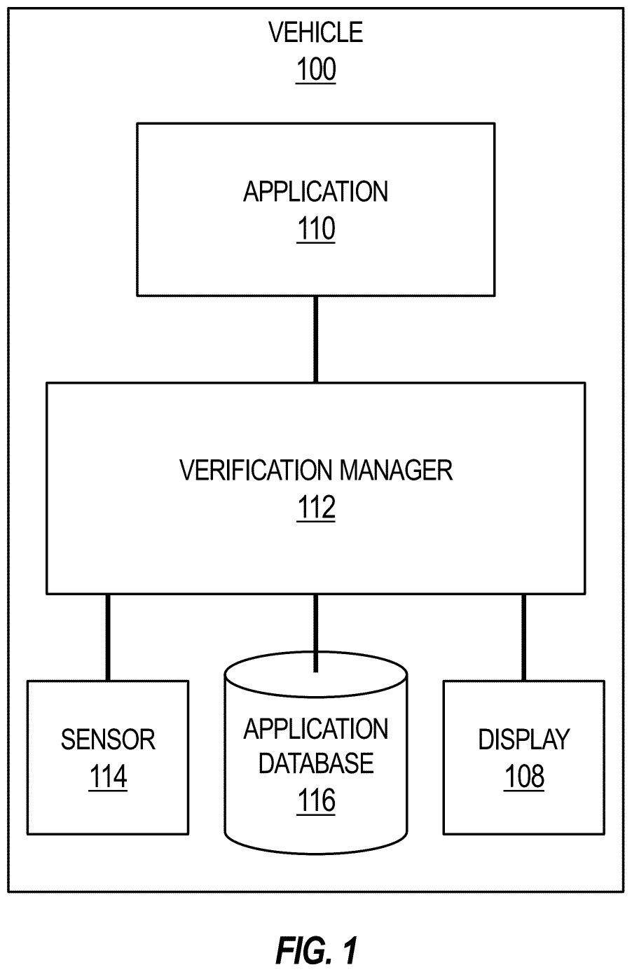

FIG. 1 is a schematic diagram of a system for vehicle state based application verification prohibition, according to at least some embodiments of the subject disclosure. The system for vehicle state based application verification prohibition includes vehicle 100, application 110, verification manager 112, sensor 114, application database 116, and display 108.

Vehicle 100 is a component of the system for vehicle state-based application verification prohibition. In at least some embodiments, vehicle 100 is configured to host ECUs. In at least some embodiments, vehicle 100 is configured to provide power and network connectivity. In at least some embodiments, vehicle 100 is configured to manage overall system health. In at least some embodiments, vehicle 100 is configured to handle transportation. In at least some embodiments, vehicle 100 is configured to interact with external networks. In at least some embodiments, vehicle 100 is configured to interface with user devices. In at least some embodiments, vehicle 100 is configured to connect to charging stations. In at least some embodiments, vehicle 100 is of the type including cars, trucks, buses, electric vehicles, hybrid vehicles, autonomous vehicles, etc. In at least some embodiments, uses of vehicle 100 include personal transportation, goods delivery, public transport, ride-sharing service, emergency response, etc.

Application 110 is a component of the system for vehicle state-based application verification prohibition. In at least some embodiments, application 110 is configured to provide specific services. In at least some embodiments, application 110 is configured to run various software. In at least some embodiments, application 110 is of the type including mobile apps, desktop software, cloud-based applications, embedded systems, and vehicle-specific apps. In at least some embodiments, uses of application 110 personal productivity, entertainment, business operations, IoT device management, smart home control, etc.

Verification manager 112 is a component of the system for vehicle state-based application verification prohibition. In at least some embodiments, verification manager 112 is configured to manage verification processes. In at least some embodiments, verification manager 112 is configured to ensure secure execution. In at least some embodiments, verification manager 112 is configured to log verification results. In at least some embodiments, verification manager 112 is configured to monitor application behavior. In at least some embodiments, verification manager 112 is configured to receive data from sensors 114. In at least some embodiments, verification manager 112 is configured to send commands to application 110. In at least some embodiments, verification manager 112 is configured to update application database 116. In at least some embodiments, verification manager 112 is configured to display status on display 108. In at least some embodiments, verification manager 112 is configured to handle system diagnostics. In at least some embodiments, verification manager 112 is configured to handle performance monitoring. In at least some embodiments, verification manager 112 is configured to handle security management. In at least some embodiments, verification manager 112 is of the type including security software, system management tools, network monitoring solutions, compliance tools, vehicle-specific management systems, etc. In at least some embodiments, uses of verification manager 112 include IT security, network management, compliance auditing, performance optimization, and remote diagnostics.

Sensor 114 is a component of the system for vehicle state-based application verification prohibition. In at least some embodiments, sensor 114 is configured to detect vehicle state. In at least some embodiments, sensor 114 is configured to measure one or more of speed, acceleration, gear position, etc. In at least some embodiments, sensor 114 is configured to monitor environmental conditions. In at least some embodiments, sensor 114 is configured to provide real-time data. In at least some embodiments, sensor 114 is configured to transmit data to verification manager 112. In at least some embodiments, sensor 114 is of the type including speedometers, accelerometers, transmission sensors, GPS modules, environmental sensors, vehicle-specific sensors, etc.

Application database 116 is a component of the system for vehicle state-based application verification prohibition. In at least some embodiments, application database 116 is configured to store application data. In at least some embodiments, application database 116 is configured to store previous execution status. In at least some embodiments, application database 116 is configured to log verification status. In at least some embodiments, application database 116 is configured to receive updates from verification manager 112. In at least some embodiments, application database 116 is configured to handle data storage. In at least some embodiments, application database 116 is of the type including SQL databases, NoSQL databases, cloud storage solutions, data warehouses, vehicle-specific data systems, etc.

Display 108 is a component of the system for vehicle state-based application verification prohibition. In at least some embodiments, display 108 is configured to show verification status. In at least some embodiments, display 108 is configured to display user prompts. In at least some embodiments, display 108 is configured to indicate application status. In at least some embodiments, display 108 is configured to receive data from verification manager 112. In at least some embodiments, display 108 is configured to display information from vehicle 100 systems. In at least some embodiments, display 108 is of the type including LCD screens, OLED displays, touchscreens, heads-up displays, digital dashboards, etc.

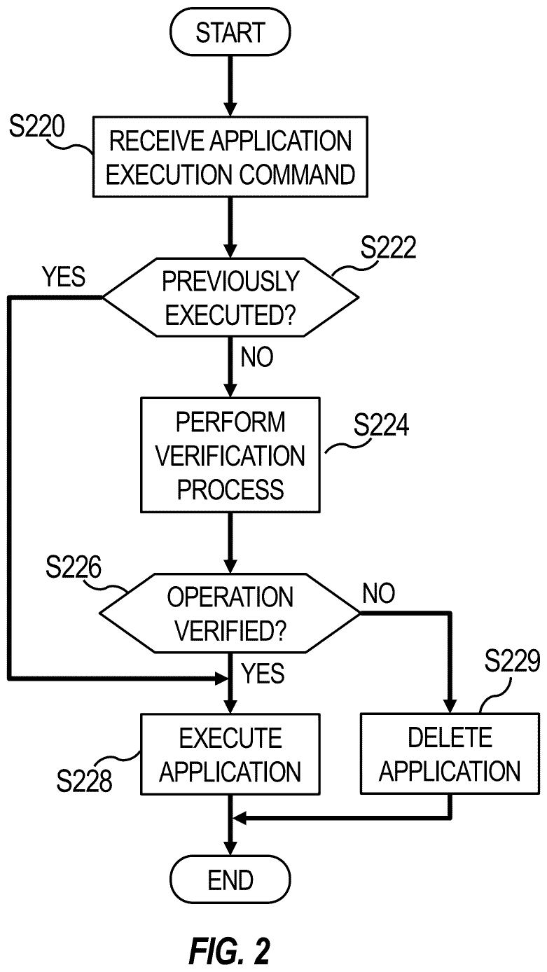

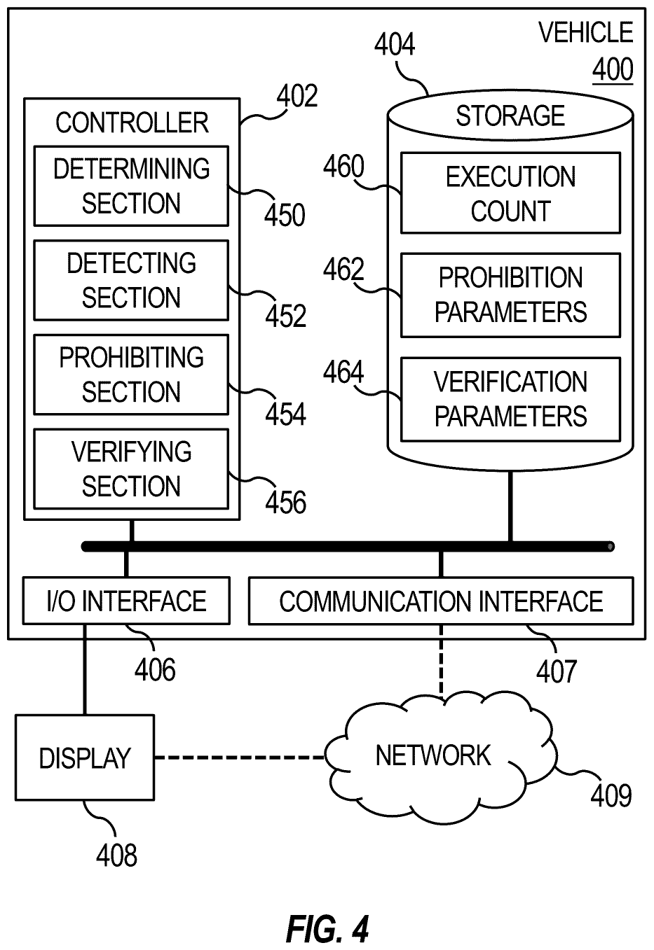

FIG. 2 is an operational flow for vehicle state based application verification prohibition, according to at least some embodiments of the subject disclosure. In at least some embodiments, the operational flow provides a method of vehicle state based application verification prohibition. In at least some embodiments, the method is performed by a controller of a vehicle, such as controller 402 of vehicle 400 of FIG. 4, described hereinafter.

At S220, the controller or a section thereof receives the application execution command. In at least some embodiments, the controller receives the command from the user interface and logs the command in the system. In at least some embodiments, the controller initiates the application execution sequence. In at least some embodiments, the controller prepares the system for application execution. In at least some embodiments, the controller updates system logs. In at least some embodiments, the controller receives a command to execute an application. In at least some embodiments, the controller receives a command to download the application before receiving the command to execute the application.

At S222, the controller or a section thereof determines whether the application has been previously executed. In at least some embodiments, the controller checks the application execution history. In at least some embodiments, the controller queries an application database, such as application database 116 of FIG. 1, for application execution history. In at least some embodiments, the controller determines whether the application is new or otherwise previously unexecuted. In response to the controller determining that the application was not previously executed, the operational flow proceeds to verification process performance at S224. In response to the controller determining that the application was previously executed, the operational flow proceeds to application execution at S228.

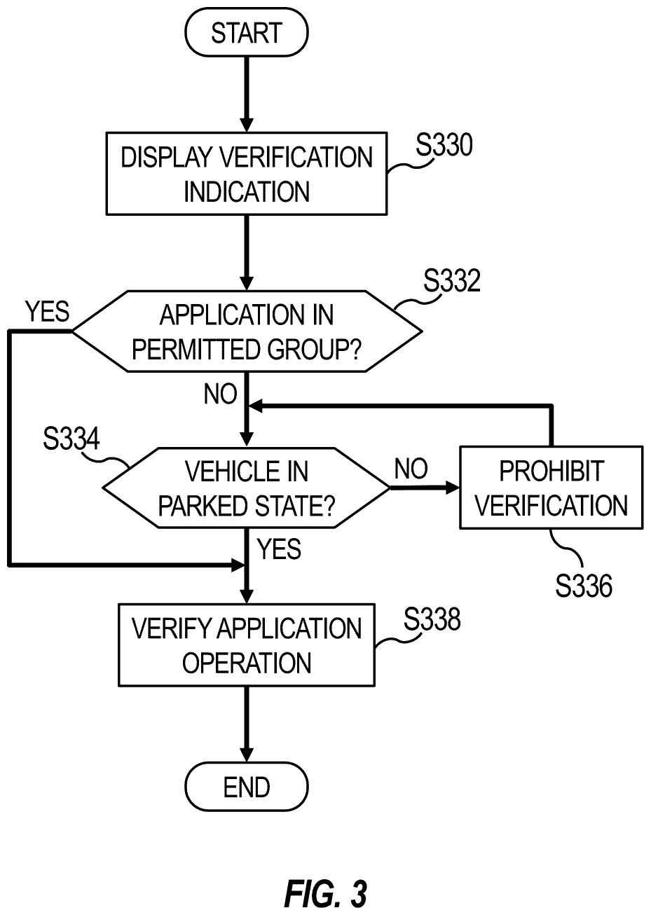

At S224, the controller or a section thereof performs the verification process. In at least some embodiments, the controller initiates a verification protocol. In at least some embodiments, the controller performs the verification process to determine whether operation of the application will be problematic. In at least some embodiments, the controller generates a verification report. In at least some embodiments, the controller increases the likelihood that only new applications that are safe are executed. In at least some embodiments, the controller performs the operational flow of FIG. 3, described hereinafter.

At S226, the controller or a section thereof determines whether the application operation is verified. In at least some embodiments, the controller makes the determination upon completion of the verification process at S224. In at least some embodiments, the controller refers to a verification report generated during the verification process at S224. In at least some embodiments, the controller confirms application operation safety and functionality before execution. In response to the controller determining that the application operation is verified, the operational flow proceeds to application execution at S228. In response to the controller determining that the application operation is not verified, the operational flow proceeds to application deletion at S229.

At S228, the controller or a section thereof executes the application. In at least some embodiments, the controller loads the application into memory. In at least some embodiments, the controller allocates necessary resources. In at least some embodiments, the controller starts application execution.

At S229, the controller or a section thereof deletes the application. In at least some embodiments, the controller deletes the application from the vehicle in response to failing to verify the operation. In at least some embodiments, the controller removes the application from the system. In at least some embodiments, the controller frees up allocated resources. In at least some embodiments, the controller updates an application blacklist. In at least some embodiments, the controller notifies the user of the deletion. In at least some embodiments, the controller updates the application status in the database.

FIG. 3 is an operational flow for verification process, according to at least some embodiments of the subject disclosure. In at least some embodiments, the operational flow provides a method of verification process. In at least some embodiments, the method is performed by a controller of a vehicle, such as controller 402 of vehicle 400 of FIG. 4, described hereinafter.

At S330, the controller or a section thereof displays the verification indication. In at least some embodiments, the controller displays an indication that the verification must be performed for the application. In at least some embodiments, the controller generates and displays a visual or auditory prompt indicating that verification is required. In at least some embodiments, the controller causes a display, such as display 108 of FIG. 1, to display the verification indication. In at least some embodiments, the controller alerts the user to the need for verification. In at least some embodiments, controller pauses any further application execution until verification is complete. In at least some embodiments, the controller waits for user input before proceeding.

At S332, the controller or a section thereof determines whether the application is in the permitted group. In at least some embodiments, the controller determines whether the application is in a first group, and the detecting is in response to determining that the application is not in the first group. In at least some embodiments, the controller checks the application against a whitelist of permitted applications. In at least some embodiments, the controller queries an application database, such as application database 116 of FIG. 1, for group classification. In at least some embodiments, the controller validates the application's digital signature. In at least some embodiments, the controller cross-references the application with known safe application repositories. In response to the application being in the permitted group, the controller proceeds to operation verification at S338. In response to the application not being in the permitted group, the controller proceeds to parked state determination at S334. In at least some embodiments, the controller makes determinations indicating whether the application can bypass a parked state check. In at least some embodiments, permitted group bypass reduces unnecessary checks for known safe applications. In at least some embodiments, permitted group bypass optimizes resource use and enhances system efficiency and user experience.

At S334, the controller or a section thereof detects whether the vehicle is in a parked state. In at least some embodiments, the controller detects whether the vehicle is in a parked state in response to determining that the application has not been previously executed. In at least some embodiments, the detecting is based on at least one of a speedometer, accelerometer, or transmission gear sensor. In at least some embodiments, the controller checks vehicle sensors such as the speedometer, accelerometer, and transmission gear sensor. In at least some embodiments, the controller verifies the parking brake status. In at least some embodiments, the controller confirms the vehicle's GPS coordinates to ensure it is stationary. In response to the controller detecting that the vehicle is in a parked state, the controller proceeds to application operation verification at S338. In response to the controller detecting that the vehicle is not in a parked state, the controller proceeds to verification prohibition at S336.

At S336, the controller or a section thereof prohibits verification. In at least some embodiments, the controller prohibits a verification process for the application from proceeding in response to detecting that the vehicle is not in the parked state. In at least some embodiments, the controller halts the verification process. In at least some embodiments, the controller displays a message indicating that verification cannot proceed while the vehicle is in motion. In at least some embodiments, the controller prevents application execution until verification can be performed. In at least some embodiments, the controller prevents application operation verification until the vehicle enters a parked state. In at least some embodiments, verification prohibition while not in a parked state ensures safety by preventing verification during driving. In at least some embodiments, verification prohibition while not in a parked state avoids potential distractions.

At S338, the controller or a section thereof verifies the application operation. In at least some embodiments, the controller verifies one or more operations of the application. In at least some embodiments, the controller allows the verification process for the application to proceed in response to detecting that the vehicle is in the parked state. In at least some embodiments, the controller executes the application in a controlled environment. In at least some embodiments, the verifying is based on whether a value recognized in the vehicle and a value displayed in the new application is equal to or less than a predetermined value. In at least some embodiments, the controller monitors application behavior and compares it with expected values. In at least some embodiments, the verifying includes prompting the user to confirm normality of the operation. In at least some embodiments, the controller prompts the user to confirm normal operation. In at least some embodiments, the controller logs the verification results in the system. In at least some embodiments, application operation verification ensures that only safe and verified applications are executed. In at least some embodiments, application operation verification maintains vehicle and user safety.

FIG. 4 is a block diagram of a hardware configuration for vehicle state based application verification prohibition, according to at least some embodiments of the subject disclosure. The hardware configuration includes vehicle 400, which interacts with display 408 directly or through network 409. In at least some embodiments, display 408 is a touch screen, a microphone, a camera, or any other device configured to detect tactile, aural, visual, etc. input. In at least some embodiments, network 409 is an ethernet network, a Controller Area Network (CAN), or any other wired or wireless network or a combination thereof. In at least some embodiments, vehicle 400 is a computer or other computing device that receives input or commands from display 408. In at least some embodiments, vehicle 400 is integrated with display 408. In at least some embodiments, vehicle 400 is a computer system that executes computer-readable instructions to perform operations for vehicle state based application verification prohibition.

Vehicle 400 includes controller 402, storage 404, input/output interface 406, and communication interface 407. In at least some embodiments, controller 402 includes a processor or programmable circuitry executing instructions to cause the processor or programmable circuitry to perform operations according to the instructions. In at least some embodiments, controller 402 includes analog or digital programmable circuitry, or any combination thereof. In at least some embodiments, controller 402 includes physically separated storage or circuitry that interacts through communication. In at least some embodiments, storage 404 includes a non-volatile computer-readable medium capable of storing executable and non-executable data for access by controller 402 during execution of the instructions. In at least some embodiments, communication interface 407 transmits and receives data from network 409. In at least some embodiments, input/output interface 406 connects to various input and output units, such as display 408, via a parallel port, a serial port, a keyboard port, a mouse port, a monitor port, and the like to accept commands and present information. In some embodiments, storage 404 is external from vehicle 400. controller 402 includes determining section 450, detecting section 452, prohibiting section 454, and verifying section 456. storage 404 includes execution count 460, prohibition parameters 462, and verification parameters 464.

Determining section 450 is the circuitry or instructions of controller 402 configured for previous execution detection. In at least some embodiments, determining section 450 is configured to determine whether the application has been previously executed. In at least some embodiments, determining section 450 utilizes storage 404 to read or record information, such as execution count 460. In at least some embodiments, determining section 450 includes sub-sections for performing additional functions, as described in the foregoing flow charts. In at least some embodiments, such sub-sections are referred to by a name associated with a corresponding function.

Detecting section 452 is the circuitry or instructions of controller 402 configured for parked state detection. In at least some embodiments, detecting section 452 is configured to detect whether a vehicle is in a parked state in response to determining that the application has not been previously executed. In at least some embodiments, detecting section 452 utilizes storage sensors to read information, such as sensor 114 of FIG. 1. In at least some embodiments, detecting section 452 includes sub-sections for performing additional functions, as described in the foregoing flow charts. In at least some embodiments, such sub-sections are referred to by a name associated with a corresponding function.

Prohibiting section 454 is the circuitry or instructions of controller 402 configured for verification prohibition. In at least some embodiments, prohibiting section 454 is configured to prohibit a verification process for the application from proceeding in response to detecting that the vehicle is not in the parked state. In at least some embodiments, prohibiting section 454 utilizes storage 404 to read or record information, such as prohibition parameters 462. In at least some embodiments, prohibiting section 454 includes sub-sections for performing additional functions, as described in the foregoing flow charts. In at least some embodiments, such sub-sections are referred to by a name associated with a corresponding function.

Verifying section 456 is the circuitry or instructions of controller 402 configured for application operation verification. In at least some embodiments, verifying section 456 is configured to verify an operation of the application. In at least some embodiments, verifying section 456 utilizes storage 404 to read or record information, such as verification parameters 464. In at least some embodiments, verifying section 456 includes sub-sections for performing additional functions, as described in the foregoing flow charts. In at least some embodiments, such sub-sections are referred to by a name associated with a corresponding function.

In at least some embodiments, the vehicle is another device capable of processing logical functions in order to perform the operations herein. In at least some embodiments, the controller and the storage need not be entirely separate devices, but share circuitry or one or more computer-readable mediums. In at least some embodiments, the storage includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein. In at least some embodiments where the vehicle is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of hardware responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer-readable medium includes a tangible device that is able to retain and store instructions for use by an instruction execution device. In some embodiments, the computer-readable medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

While embodiments of the present invention have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

Vehicle state based application verification prohibition is implemented by receiving a command to execute an application, determining whether the application has been previously executed, detecting whether a vehicle is in a parked state in response to determining that the application has not been previously executed, and prohibiting a verification process for the application from proceeding in response to detecting that the vehicle is not in the parked state.

In at least some embodiments, vehicle state based application verification prohibition is further implemented by allowing the verification process for the application to proceed in response to detecting that the vehicle is in the parked state. In at least some embodiments, vehicle state based application verification prohibition is further implemented by displaying an indication that the verification must be performed for the application. In at least some embodiments, the detecting is based on at least one of a speedometer, accelerometer, or transmission gear sensor. In at least some embodiments, vehicle state based application verification prohibition is further implemented by verifying an operation of the application. In at least some embodiments, the verifying includes prompting the user to confirm normality of the operation. In at least some embodiments, the verifying is based on whether a value recognized in the vehicle and a value displayed in the new application is equal to or less than a predetermined value. In at least some embodiments, vehicle state based application verification prohibition is further implemented by deleting the application from the vehicle in response to failing to verify the operation. In at least some embodiments, vehicle state based application verification prohibition is further implemented by determining whether the application is in a first group; wherein the detecting is in response to determining that the application is in the first group. In at least some embodiments, vehicle state based application verification prohibition is further implemented by receiving a command to download the application before receiving the command to execute the application.

Vehicle state based application verification prohibition is implemented by receiving a command to execute an application, determining whether the application has been previously executed, detecting whether a vehicle is in a parked state in response to determining that the application has not been previously executed, and prohibiting a verification process for the application from proceeding in response to detecting that the vehicle is not in the parked state.

In at least some embodiments, vehicle state based application verification prohibition further includes allowing the verification process for the application to proceed in response to detecting that the vehicle is in the parked state. In at least some embodiments, vehicle state based application verification prohibition further includes displaying an indication that the verification must be performed for the application. In at least some embodiments, the detecting is based on at least one of a speedometer, accelerometer, or transmission gear sensor. In at least some embodiments, vehicle state based application verification prohibition further includes verifying an operation of the application.

Vehicle state based application verification prohibition is implemented by a controller including circuitry configured to perform operations including:, receiving a command to execute an application, determining whether the application has been previously executed, detecting whether a vehicle is in a parked state in response to determining that the application has not been previously executed, and prohibiting a verification process for the application from proceeding in response to detecting that the vehicle is not in the parked state.

In at least some embodiments, vehicle state based application verification prohibition further includes allowing the verification process for the application to proceed in response to detecting that the vehicle is in the parked state. In at least some embodiments, vehicle state based application verification prohibition further includes displaying an indication that the verification must be performed for the application. In at least some embodiments, the detecting is based on at least one of a speedometer, accelerometer, or transmission gear sensor. In at least some embodiments, vehicle state based application verification prohibition further includes verifying an operation of the application.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A non-transitory computer-readable medium including instructions that, in response to execution by one or more processors, cause performance of operations comprising:
receiving a command to execute an application;
determining whether the application has been previously executed;
detecting whether a vehicle is in a parked state in response to determining that the application has not been previously executed; and
prohibiting a verification process for the application from proceeding in response to detecting that the vehicle is not in the parked state.

2. The computer-readable medium of claim 1, further comprising
allowing the verification process for the application to proceed in response to detecting that the vehicle is in the parked state.

3. The computer-readable medium of claim 1, further comprising
displaying an indication that the verification must be performed for the application.

4. The computer-readable medium of claim 1, wherein the detecting is based on at least one of a speedometer, accelerometer, or transmission gear sensor.

5. The computer-readable medium of claim 1, further comprising
verifying one or more operations of the application.

6. The computer-readable medium of claim 1, wherein the verifying includes prompting the user to confirm normality of the operation.

7. The computer-readable medium of claim 1, wherein the verifying is based on whether a value recognized in the vehicle and a value displayed in the new application is equal to or less than a predetermined value.

8. The computer-readable medium of claim 1, further comprising
deleting the application from the vehicle in response to failing to verify the operation.

9. The computer-readable medium of claim 1, further comprising
determining whether the application is in a first group;
wherein the detecting is in response to determining that the application is not in the first group.

10. The computer-readable medium of claim 1, further comprising
receiving a command to download the application before receiving the command to execute the application.

11. A method comprising:
receiving a command to execute an application;
determining whether the application has been previously executed;
detecting whether a vehicle is in a parked state in response to determining that the application has not been previously executed; and
prohibiting a verification process for the application from proceeding in response to detecting that the vehicle is not in the parked state.

12. The method of claim 11, further comprising
allowing the verification process for the application to proceed in response to detecting that the vehicle is in the parked state.

13. The method of claim 11, further comprising
displaying an indication that the verification must be performed for the application.

14. The method of claim 11, wherein the detecting is based on at least one of a speedometer, accelerometer, or transmission gear sensor.

15. The method of claim 11, further comprising
verifying one or more operations of the application.

16. A device comprising:
a controller including circuitry configured to perform operations including
receiving a command to execute an application,
determining whether the application has been previously executed,
detecting whether a vehicle is in a parked state in response to determining that the application has not been previously executed, and
prohibiting a verification process for the application from proceeding in response to detecting that the vehicle is not in the parked state.

17. The device of claim 16, further comprising
allowing the verification process for the application to proceed in response to detecting that the vehicle is in the parked state.

18. The device of claim 16, further comprising
displaying an indication that the verification must be performed for the application.

19. The device of claim 16, wherein the detecting is based on at least one of a speedometer, accelerometer, or transmission gear sensor.

20. The device of claim 16, further comprising
verifying one or more operations of the application.
